(19) United States
(12) Patent Application Publication
(10) Pub. No.: US 2025/0380688 A1
(43) Pub. Date: Dec. 18, 2025

(54) SUSTAINED RELEASE PHEROMONE PREPARATION AND CONTROL METHOD USING THE SAME

(71) Applicant: Shin-Etsu Chemical Co., Ltd., Tokyo (JP)

(72) Inventors: Tatsuya HOJO, Joetsu-shi (JP); Takeru WATANABE, Joetsu-shi (JP); Yuki MIYAKE, Joetsu-shi (JP); Akihiro BABA, Joetsu-shi (JP)

(21) Appl. No.: 19/227,777

(22) Filed: Jun. 4, 2025

(30) Foreign Application Priority Data
Jun. 13, 2024 (JP) 2024-095615

(51) Int. Cl. A01N 25/18; A01N 37/02; A01P 17/00

(52) U.S. Cl. CPC A01N 25/18; A01N 37/02; A01P 17/00

(57) ABSTRACT

An aspect of the present invention provides a sustained release pheromone preparation comprising at least a carboxylic acid compound, the carboxylic acid compound being a sex pheromone; and a container having the carboxylic acid compound enclosed therein, wherein the container comprises, as at least a part of the container, a membrane of a linear aliphatic polyester having at least one selected from the following repeating unit (I):

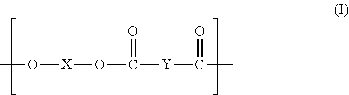

in which X and Y represent, independently of each other, a divalent hydrocarbon group having 1 to 8 carbon atoms.

Another aspect of the present invention provides a method for controlling a pest, the method comprising at least a step of placing the aforesaid sustained release pheromone preparation in a field to release the aforesaid carboxylic acid compound from inside the sustained release pheromone preparation.

### TECHNICAL FIELD

The present invention relates to a sustained release pheromone preparation. Further, the present invention relates to a control method using the same.

### BACKGROUND ART

Currently, there is a strong need to establish mass trapping and mating disruption as pest control technologies that use sex pheromones as an alternative to pesticide spraying. To reduce the mating rate of female adults in the field, mass trapping uses the sex pheromone of the target pest as an attractant in traps to exterminate large amounts of male adults in the field, and mating disruption disrupts communication between males and females by releasing large amounts of the sex pheromone into the atmosphere.

To release a certain amount of the sex pheromone over a long period, a sustained release pheromone preparation is used in which the sex pheromone is enclosed in a container such as a cap, tubule, laminated bag, or capsule made of a substance that can control the release rate, such as rubber, polyethylene, polypropylene, ethylene-vinyl acetate copolymer, and poly(vinyl chloride). Among such substances, polyolefin plastics such as polyethylene and ethylene-vinyl acetate copolymer (EVA) are available in a wide variety of forms and are inexpensive due to their widespread use. Polyolefin plastics also have excellent formability, allowing a wide range of forming such as extrusion, film molding, stretch molding, and injection molding. Excellent mechanical strength of polyolefin plastics, and particularly their mechanical strength at low temperatures, makes them suitable for use in cold seasons and regions. Sustained release pheromone preparations have been reported in which, for example, aldehyde compounds and acetate compounds, which are well-known as some of the sex pheromones of lepidopteran pests, are enclosed in a container made of a membrane of polyethylene, ethylene-vinyl acetate copolymer, or linear aliphatic polyester and are released by passing through the container (Patent Literature 1 below).

However, carboxylic acid compounds are substantially not released from containers made of polyethylene. Meanwhile, a sustained release pheromone preparation that can maintain a high release rate of carboxylic acid has been reported in which an ethylene-vinyl acetate copolymer having a vinyl acetate content ratio within a prescribed range was used as the container (Patent Literature 2 below). It is also reported that the release rate increases as the vinyl acetate content ratio increases.

### PRIOR ART

### Patent Literatures

[Patent Literature 1] Japanese Patent Application Laid-Open No. 2021-161058
[Patent Literature 2] Japanese Patent Application Laid-Open No. 2012-126692

### OBJECT OF THE INVENTION

Patent Literature 1 reports that the vinyl acetate content of the copolymer is preferably 4 to 20% by mass in view of release performance and processibility. When, however, the vinyl acetate content ratio of an ethylene-vinyl acetate copolymer is high, fluidity undesirably increases in response to a temperature increase when processing, which results in many defects such as breakage when manufacturing a container by extrusion molding, or leakage when sealing the ends due to a nonuniform membrane thickness. A low melting point and a low flexural modulus are possible reasons for such defects. When the vinyl acetate content ratio of an ethylene-vinyl acetate copolymer is, for example, 4% by mass, the melting point is 107° C., and the flexural modulus is 200 MPa. When the vinyl acetate content ratio of an ethylene-vinyl acetate copolymer is 10% by mass or higher, the melting point falls below 100° C., and the flexural modulus is 100 MPa or lower.

Furthermore, the most common type of container, tube preparations, are manufactured continuously by ultrasonically sealing an extrusion-molded tube filled with a liquid and by cutting the tube to a regular dimension. The ultrasonic seal is made by pressing a vibrating horn, which is a transducer, against the tube to fuse the tube and seal the liquid. Therefore, the flexural modulus of the container material is highly relevant when pressing the horn against the tube. Because the flexural modulus decreases at high temperatures, it is considered that tearing may occur more easily when fusing by vibrations. Furthermore, the liquid at the sealing portion is extruded longitudinally, thereby increasing the internal pressure of the tube. In particular, the liquid continuously moves backward due to the continuous sealing, and the internal pressure continues to increase. Therefore, if a material having a low flexural modulus and a low melting point is used in a continuous manufacturing process such as the above, tearing due to the internal pressure is problematic.

Recent years have seen a strong demand to reduce the environmental impact and to enable natural disintegration and biodegradability of polymers used in sustained release pheromone preparations.

It is therefore desirable to develop a sustained release pheromone preparation in continuous manufacturing with an extremely low defect occurrence rate, to be used in a container made of a biodegradable material.

It is noted that no sustained release pheromone preparation in which a carboxylic acid compound is enclosed in a container made of a linear aliphatic polyester has been reported.

### SUMMARY OF THE INVENTION

As a result of intensive research to overcome the aforesaid problems of the prior art, the present inventors have now found that by using a carboxylic acid compound sex pheromone and a container made of a prescribed aliphatic polyester, the defect occurrence rate of the resulting preparation can be reduced, continuous manufacturing is possible, and a certain release rate of the carboxylic acid sex pheromone can be slowly released from the preparation over a long period, thereby completing the present invention.

According to an aspect of the present invention, there is provided a sustained release pheromone preparation comprising at least:
a carboxylic acid compound, the carboxylic acid compound being a sex pheromone; and
a container having the carboxylic acid compound enclosed therein,
wherein the container comprises, as at least a part of the container, a membrane of a linear aliphatic polyester having at least one selected from the following repeating unit (I):

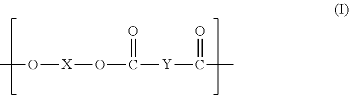

in which X and Y represent, independently of each other, a divalent hydrocarbon group having 1 to 8 carbon atoms.

In another aspect of the present invention, there is provided a method for controlling a pest, the method comprising at least a step of placing the aforesaid sustained release pheromone preparation in a field to release the aforesaid carboxylic acid compound from inside the sustained release pheromone preparation.

According to the sustained release preparation according to the present invention, the defect occurrence rate of the sustained release pheromone preparation obtained can be reduced. Continuous production of the aforesaid pheromone preparation is possible as well. A high release amount of a carboxylic acid sex pheromone may be maintained throughout the adult outbreak period.

### DETAILED DESCRIPTION OF THE INVENTION

A sustained release pheromone preparation of the present invention contains at least a carboxylic acid compound as a sex pheromone. Although the aforesaid carboxylic acid compound may be a natural product extracted from a pest, a synthetic product is preferred. By using said synthetic product, a preferred industrial application may be ensured.

Although the carboxylic acid compound is not particularly limited as long as the carboxylic acid compound has a carboxyl group, the carboxylic acid compound is preferably a medium-chain or long-chain fatty acid having 6 to 21 carbon atoms, including the carbon atoms of the carboxyl groups. When there are six or fewer carbon atoms, including the carbon atoms of the carboxyl groups, an appropriate release rate may not be obtained because the transmission rate of the sex pheromone through the membrane is high, even when the wall of the container is thick. On the other hand, when there are 21 or more carbon atoms, including the carbon atoms of the carboxyl groups, appropriate release control may not be possible because the transmission rate of the sex pheromone through the membrane is low. Additionally, few pests have a sex pheromone with less than 6 or more than 21 carbon atoms, including the carbon atoms of the carboxyl groups, and so there is less incentive to develop a preparation.

Fatty acids are discriminated as short-chain, medium-chain, and long-chain fatty acids according to the number of carbon atoms, including the carbon atoms of the carboxyl groups. The number carbon atoms, including the carbon atoms of the carboxyl groups, is 5 or lower for short-chain fatty acids, 6 to 12 for medium-chain fatty acids, 13 to 21 for long-chain fatty acids, and 22 or higher for very-long-chain fatty acids. A fatty acid is a carboxylic acid with a carboxyl group attached to the end of an aliphatic hydrocarbon skeleton.

The carboxylic acid compound may be linear, branched-chain, or cyclic, may have one or more carboxyl groups (COOH), and may be a saturated or unsaturated carboxylic acid.

Specific examples of the carboxylic acid compound include linear or branched-chain saturated fatty acids such as hexanoic acid, heptanoic acid, octanoic acid, nonanoic acid, decanoic acid, dodecanoic acid, 3,5-dimethyldodecanoic acid, tetradecanoic acid, pentadecanoic acid, hexadecanoic acid, heptadecanoic acid, octadecanoic acid, icosanoic acid, and heneicosanoic acid; and unsaturated fatty acids such as hexenoic acid, heptenoic acid, octenoic acid, octadienoic acid, nonenoic acid, nonadienoic acid, decenoic acid, decadienoic acid, undecenoic acid, E-5-undecenoic acid, Z-5-undecenoic acid, dodecenoic acid, dodecadienoic acid, tetradecenoic acid, tetradecadienoic acid, pentadecenoic acid, pentadecadienoic acid, hexadecenoic acid, hexadecadienoic acid, hexadecatrienoic acid, heptadecenoic acid, heptadecadienoic acid, octadecenoic acid, octadecadienoic acid, octadecatrienoic acid, nonadecenoic acid, nonadecadienoic acid, icosenoic acid, icosadienoic acid, icosatrienoic acid, heneicosenoic acid, heneicosadienoic acid, and (E, Z)-3,5-tetradecadienoic acid.

The carboxylic acid compound, when including the carbon atoms of the carboxyl groups, is more preferably a saturated or unsaturated monocarboxylic acid having 11 to 17 carbon atoms, even more preferably a saturated or unsaturated monocarboxylic acid having 12 to 16 carbon atoms, and particularly preferably a saturated or unsaturated monocarboxylic acid having 13 to 15 carbon atoms.

In the sustained release pheromone preparation according to the present invention, additives such as, for example, an antioxidant and/or a UV absorber may be added together with the carboxylic acid compound. Examples of the antioxidant include synthetic antioxidants such as BHT (butylhydroxytoluene), BHA (butylhydroxyanisole), isoamyl gallate, propyl gallate, and 2,5-di-t-butylhydroquinone (DBH); and natural antioxidants such as nordihydroguaiaretic acid (NDGA) and gum guaiac. Examples of the UV absorber include p-aminobenzoic acid derivatives such as octyldimethyl p-aminobenzoic acid; benzophenone derivatives such as oxybenzone (2-hydroxy-4-methoxybenzophenone) and 2-hydroxy-4-octoxybenzophenone; methoxycinnamic acid derivatives; salicylic acid derivatives; and 2-(2′-hydroxy-3′-t-butyl-5′-methylphenyl)-5-chlorobenzotriazole. Although not particularly limited, the content of each additive, per 100 parts by mass carboxylic acid compound, is preferably 0.1 to 5 parts by mass, and the total additive content is preferably 0.2 to 10 parts by mass.

Sex pheromones other than carboxylic acid compounds may be added to the carboxylic acid compounds because the sex pheromones of some pests may contain additional sex pheromone components other than carboxylic acid compounds. Examples of sex pheromones other than carboxylic acid compounds may include aldehyde compounds, acetate compounds, alcohol compounds, ketone compounds, and hydrocarbon compounds, but are not particularly limited as long as a certain amount of the sex pheromone may be released from the container over a certain period, and the sex pheromone has high reactivity and/or decomposability with carboxylic acid compounds.

Examples of pests having carboxylic acid compounds as sex pheromones include, for example, the following pests. The pest names are followed by the carboxylic acid compounds which are the sex pheromones.

California prionus (Prionus carifornicus): 3,5-dimethyldodecanoic acid.

Varied carpet beetle (anthrenus verbasci): (Z)-5-undecenoic acid and (E)-5-undecenoic acid.

Black carpet beetle (Attagenus unicolor): (E, Z)-3,5-tetradecadienoic acid.

Reasons for the lack of development of a sustained release pheromone preparation using carboxylic acid sex pheromones and aliphatic polyester containers to date may be as follows. Polyester has properties similar to polyethylene, not only for acid resistance, but also for some indices of mechanical strength such as tensile strength and elongation percentage, and so the properties of polyethylene and polyester as polymers are considered to be similar. Therefore, because containers made of polyethylene could not release carboxylic acid compounds, it would be expected that containers made of polyester likewise would not easily release carboxylic acid compounds, and so the use of polyester in containers for releasing carboxylic acid was not considered. However, it was unforeseen that, unlike containers made of polyethylene, a sustained release pheromone preparation that can release a certain amount of a carboxylic acid compound may be obtained by using a container that contains, as at least a part of the container, polyester, and particularly linear aliphatic polyester containing at least one selected from following repeating unit (I).

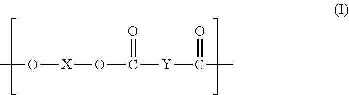

wherein X and Y represent, independently of each other, a divalent hydrocarbon group having 1 to 8 carbon atoms.

X and Y represent, independently of each other, a divalent hydrocarbon group having 1 to 8 carbon atoms. Specific examples of X and Y include a methylene group, an ethylene group, a vinylene group, a propylene group, a propanediyl group, a butanediyl group, a pentanediyl group, a hexanediyl group, a heptanediyl group, and an octanediyl group. An ethylene group and a butanediyl group are particularly preferred. X and Y are preferably, independently of each other, a divalent saturated hydrocarbon group having 1 to 5 carbon atoms.

Although the preparation process of the repeating unit (I) is not particularly limited, the repeating unit (I) may be obtained, for example, by condensation of a linear dicarboxylic acid and a linear diol.

Examples of dicarboxylic acids forming the dicarboxylic acid unit of the repeating unit (I) include linear compounds such as malonic acid, succinic acid, glutaric acid, adipic acid, pimelic acid, suberic acid, sebacic acid, and fumaric acid. The dicarboxylic acid unit of the repeating unit (I) is preferably succinic acid and adipic acid. By using said succinic acid and adipic acid, a preferred compatibility with the polarity of the sex pheromone and a preferred membrane permeation mechanism due to the molecular diameter of the sex pheromone and the crystallinity of the polymer membrane or the gap structure of the polymer chains inside the polymer membrane may be ensured.

Examples of diols forming the diol unit of the repeating unit (I) include linear compounds such as ethylene glycol, propylene glycol, propanediol, butanediol, pentanediol, hexanediol, octanediol, and decanediol. The diol forming the diol unit of the repeating unit (I) is most preferably butanediol. By using said butanediol, a most preferred compatibility with the polarity of the sex pheromone and a most preferred membrane permeation mechanism due to the molecular diameter of the sex pheromone and the crystallinity of the polymer membrane or the gap structure of the polymer chains inside the polymer membrane may be ensured.

Poly(ethylene succinate) (PES) is obtained by subjecting succinic acid, which forms a dicarboxylic acid unit, and ethylene glycol, which forms a diol unit, to a condensation polymerization reaction. Similarly, poly(ethylene adipate) (PEA) is obtained by subjecting adipic acid and ethylene glycol to condensation polymerization. Thus, examples of the linear aliphatic polyester include poly(ethylene malonate), poly(ethylene glutarate), poly(ethylene suberate), poly(ethylene fumarate), poly(propylene succinate), poly(propylene malonate), poly(propylene adipate), poly(propylene glutarate), poly(propylene suberate), poly(propylene fumarate), poly(butylene succinate) (PBS), poly(butylene malonate), poly(butylene adipate) (PBA), poly(butylene glutarate), poly(butylene suberate), poly(butylene fumarate), poly(propylene succinate), poly(propylene malonate), poly(propylene adipate), poly(pentylene glutarate), poly(pentylene suberate), poly(pentylene fumarate), poly(hexylene succinate), poly(hexylene malonate), poly(hexylene adipate), poly(hexylene glutarate), poly(hexylene suberate), poly(propylene fumarate), poly(octylene succinate), poly(octylene malonate), poly(octylene adipate), poly(octylene glutarate), poly(octylene suberate), and poly(propylene fumarate).

Poly(ethylene succinate) (PES), poly(ethylene adipate) (PEA), poly(butylene succinate) (PBS), and poly(butylene adipate) (PBA) are preferred. By using said poly(ethylene succinate), poly(ethylene adipate), poly(butylene succinate), and poly(butylene adipate), a preferred plasticity of a molded product may be ensured. Poly(butylene succinate) (PBS) is more preferred. By using said poly(butylene succinate), a more preferred plasticity of a molded product may be ensured.

Examples of a linear aliphatic polyester formed of two types of repeating units selected from the repeating unit (I) include, for example, a linear aliphatic polyester that is a condensation polymer of one type of dicarboxylic acid and two types of diols; and a linear aliphatic polyester that is a condensation polymer of two types of dicarboxylic acids and one type of diol. The linear aliphatic polyester is preferably a condensation polymer of two types of dicarboxylic acids and one type of diol such as, for example, poly(ethylene succinate adipate) (PESA), poly(propylene succinate adipate), and poly(butylene succinate adipate) (PBSA). Poly(butylene succinate adipate) (PBSA) is more preferred. By using said poly(butylene succinate adipate), a more preferred plasticity of a molded product may be ensured.

The container used in the present invention preferably contains more than 50% by mass up to 100% by mass of the repeating unit (I) among all of the repeating units, and more preferably contains no less than 70% by mass and no more than 100% by mass. A linear aliphatic polyester that contains 100% by mass of the repeating unit (I) among all of the repeating units is a linear aliphatic polyester formed of one or more types of repeating units selected from the repeating unit (I), and good results were obtained even at 100% by mass (see Examples 1 to 3 that will be explained below). On the other hand, when the repeating unit (I) is not 100% by mass, a blended polymer or copolymer containing more than 0% by mass and less than 50% by mass, and preferably more than 0% by mass up to 30% by mass of an aliphatic polyester selected from polylactic acid, polycaprolactone, and polyhydroxybutyric acid may be used. Specifically, examples of the copolymer include poly(caprolactone/butylene succinate). Examples of the blended polymer include poly(butylene succinate/adipate) and polycaprolactone.

The sequence of one or more types of repeating units selected from the repeating unit (I) with the aliphatic polyester selected from polylactic acid, polycaprolactone, and polyhydroxybutyric acid is not particularly limited, and may be that of, for example, a random copolymer, an alternating copolymer, a block copolymer, or a graft copolymer. The sequence is preferably that of a random copolymer.

When poly(butylene succinate adipate), which is a copolymer of butylene succinate and butylene adipate, is used, a molar ratio of butylene succinate units (repeating units): butylene adipate units (repeating units) is preferably in the range of 95:5 to 5:95, and more preferably in the range of 90:10 to 70:30. By using said preferred range and said more preferred range, a preferred reaction rate of copolymerization and molecular weight increase and a more preferred reaction rate of copolymerization and molecular weight increase may be ensured.

The aliphatic polyester has a flexural modulus of preferably more than 200 Pa, more preferably 300 Pa or higher, and even more preferably 330 Pa or higher. Although not particularly limited, the upper limit of the flexural modulus is, for example, 1,000 Pa. The flexural modulus is measured at 23° C. based on JIS 7171.

The aliphatic polyester has a melting point of preferably 50 to 150° C., more preferably 60 to 130° C., and even more preferably 70 to 120° C. The melting point is measured based on JIS K7121.

As long as the aliphatic polyester has the aforesaid preferred ranges of the flexural modulus and the melting point, the occurrence rate of defects such as breakage partway through due to a fluidity increase caused by heating during manufacturing of the container by extrusion molding, or a nonuniform membrane thickness causing leakage when sealing the ends, may be reduced to a preferred level.

At least a part of the container that encloses the carboxylic acid compound contains a linear aliphatic polyester membrane containing at least one repeating unit selected from the repeating unit (I). This is because the carboxylic acid compound is released by passing through the linear aliphatic polyester membrane, and so the slow release of the carboxylic acid compound may be maintained if the linear aliphatic polyester membrane is present in at least a part of the container. Accordingly, the entire container may be formed of a linear aliphatic polyester membrane containing at least one repeating unit selected from the repeating unit (I).

The configuration of the container enclosing the carboxylic acid compound is preferably a membrane permeation-type pheromone preparation such as a tube, a capsule, an ampule, or a bag. Particularly, the tube form has an inner diameter in the range of preferably 0.5 mm to 2.5 mm, and more preferably 0.6 to 1.6 mm; a surface area preferably in the range of 600 to 4,000 mm², and more preferably 690 to 2,000 mm²; and a membrane thickness preferably in the range of 0.20 to 0.75 mm, and more preferably 0.25 to 0.65 mm. By using said preferred ranges and said more preferred ranges, a preferred fillability and release of the sex pheromone and a more preferred fillability and release of the sex pheromone may be ensured.

An additive such as, for example, a colorant, an antioxidant, a UV absorber, an antiblocking agent, and a lubricant may be added to the container itself for a container formed, at least partially, of a linear aliphatic polyester membrane contain at least one repeating unit selected from the repeating unit (I).

The colorant may be added, per mass of the container, to be preferably 3% or lower, and more preferably 1% or lower. By using said preferred amount and said more preferred amount, a preferred prevention of degradation of the sex pheromone due to ultraviolet light and a more preferred prevention of degradation of the sex pheromone due to ultraviolet light may be ensured. Examples of the colorant include an inorganic colorant and an organic colorant. Examples of the inorganic colorant include iron oxide, chromium oxide, titanium oxide, and carbon black. Examples of the organic colorant include a polycyclic pigment and an azo pigment.

The antioxidant and/or the UV absorber may be added, in total per mass of the container, to be preferably 1% or lower. By using said preferred amount, a preferred prevention of degradation of the polymer when used may be ensured. Examples of the antioxidant include a phenolic antioxidant, a sulfur antioxidant, and a phosphorus antioxidant. Examples of the UV absorber include benzotriazoles and benzophenones.

The antiblocking agent and/or the lubricant may be added, in total per mass of the container, to be preferably 1% or lower. By using said preferred amount, a preferred improvement of the processibility of the container may be ensured. Examples of the antiblocking agent include a metal salt of a higher fatty acid and an inorganic powder. Examples of the lubricant include hydrocarbons, alcohols, higher fatty acids, esters, polyhydric alcohol partial esters, higher fatty acid metal salts, natural waxes, fatty acid amides, and polymers.

The sustained release pheromone preparation is obtained by forming a container by blow molding, extrusion, or the like and by loading and enclosing a liquid carboxylic acid compound. In some cases, a liquid carboxylic acid compound may be loaded and enclosed using the same path that allows air to be pushed out simultaneously with the forming.

A particularly preferred combination of the sex pheromone and the container is a saturated or unsaturated monocarboxylic acid having 13 to 15 carbon atoms and a container formed, at least partially, of a linear aliphatic polyester membrane containing at least one repeating unit selected from the repeating unit (I), in which X and Y represent, independently of each other, a divalent saturated hydrocarbon group having 1 to 5 carbon atoms.

### EXAMPLES

The present invention will be described with reference to the following Examples. It should be noted that the present invention is not limited to or by the Examples.

### Example 1

Poly(butylene succinate) (BioPBS FZ91, Mitsubishi Chemical Corporation) was extruded into a tube form having an inner diameter of 0.60 mm and a membrane thickness of 0.30 mm, and then cut to a length of 200 mm to obtain a polymer tubule (tube). The polymer tubule was filled with 50 mg of the sex pheromone of the California prionus, 3,5-dimethyldodecanoic acid, 0.5 mg of the stabilizer, 5-di-tert-butylhydroquinone (DBH), and 0.5 mg of 2-(2′-hydroxy-3′-t-butyl-5′-methylphenyl)-5-chlorobenzotriazole (HBMCBT). The polymer tubule container was then heat-sealed at both ends to form a sustained release pheromone preparation. The sustained release pheromone preparations thus obtained that had leakage due to pinholes or fusion defects were deemed defective, and the defect occurrence rate was calculated. The melting points and flexural moduli of the polymer tubule materials used are shown in Table 1 below, and the results are shown in Table 2 below.

Fifteen of the sustained release pheromone preparations thus obtained were left under conditions of 30° C. and a wind velocity of 1.0 m/sec to release the mixture liquid inside the sustained release pheromone preparation.

To calculate the release rate per day, three sustained release pheromone preparations were recovered after each of 30, 60, 90, 120, and 150 days. The residual amount of 3,5-dimethyldodecanoic acid was quantified by an internal standard method of gas chromatography and averaged for the three samples of each period. The difference (the reduction amount) from the average value of the previous (in the case of 30 days, from the start of the measurements, and in the case of 60 days, from the average value at 30 days) divided by the number of days was calculated as the release rate per day per preparation for each period (“after 30 days” being 0 to 30 days, and “after 60 days” being 30 to 60 days). The ratio of the release rate after 150 days to the release rate after 30 days also was calculated. The results are shown in Table 3 below. The release behavior under these conditions correlates with the release behavior in an actual field, and similar release behavior was confirmed in an actual field.

### Example 2

Sustained release pheromone preparations were prepared as in Example 1, with the proviso that the polymer tubule material was poly(ethylene succinate) (Lunare SE, Nippon Shokubai Co., Ltd.), and a release test was carried out after calculating the defect occurrence rate. The melting points and flexural moduli of the polymer tubule material used are shown in Table 1 below, and the results of Example 2 are shown in Tables 2 and 3 below.

### Example 3

Sustained release pheromone preparations were prepared as in Example 1, with the proviso that the polymer tubule material was poly(butylene succinate adipate) (BioPBS FD92, Mitsubishi Chemical Corporation), and a release test was carried out after calculating the defect occurrence rate. The melting points and flexural moduli of the polymer tubule material used are shown in Table 1 below, and the results of Example 3 are shown in Tables 2 and 3 below.

### Example 4

Sustained release pheromone preparations were prepared as in Example 1, with the proviso that the polymer tubule material was a mixed resin having a mass ratio of 7:3 of poly(butylene succinate adipate) (BioPBS FD92, Mitsubishi Chemical Corporation): polycaprolactone (CAPA 6800, Ingevity Corporation), and a release test was carried out after calculating the defect occurrence rate. The melting points and flexural moduli of the polymer tubule material used are shown in Table 1 below, and the results of Example 4 are shown in Tables 2 and 3 below.

### Example 5

Sustained release pheromone preparations were prepared as in Example 1, with the proviso that the polymer tubule material was a mixed resin having a mass ratio of 7:3 of poly(butylene succinate adipate) (BioPBS FD92, Mitsubishi Chemical Corporation): polycaprolactone (CAPA 6800, Ingevity Corporation), and the membrane thickness of the polymer tubule of the resin was 0.60 mm. A release test was carried out after calculating the defect occurrence rate. The melting points and flexural moduli of the polymer tubule material used are shown in Table 1 below, and the results of Example 5 are shown in Tables 2 and 3 below.

### Comparative Example 1

Sustained release pheromone preparations were prepared as in Example 1, with the proviso that the polymer tubule material was high-density polyethylene (Niporon Hard, Tosoh Corporation), and a release test was carried out after calculating the defect occurrence rate. The melting points and flexural moduli of the polymer tubule material used are shown in Table 1 below, and the results of Comparative Example 1 are shown in Tables 2 and 3 below.

### Comparative Example 2

Sustained release pheromone preparations were prepared as in Example 1, with the proviso that the polymer tubule material was an ethylene-vinyl acetate copolymer (Novatec EVA LV113, Japan Polypropylene Corporation) having a vinyl acetate content of 4% by mass, and a release test was carried out after calculating the defect occurrence rate. The melting points and flexural moduli of the polymer tubule material used are shown in Table 1 below, and the results of Comparative Example 2 are shown in Tables 2 and 3 below.

### Comparative Example 3

Sustained release pheromone preparations were prepared as in Example 1, with the proviso that the polymer tubule material was ethylene-vinyl acetate copolymer (Novatec EVA LV342, Japan Polypropylene Corporation) having a vinyl acetate content of 10% by mass, and a release test was carried out after calculating the defect occurrence rate. The melting points and flexural moduli of the polymer tubule material used are shown in Table 1 below, and the results of Comparative Example 3 are shown in Tables 2 and 3 below.

TABLE 1

| | | Melting | Flexural |
|---|---|---|---|
| | | point | modulus |
| | Polymer tubule material | (° C.) | (MPa) |
| Example 1 | Poly(butylene succinate) | 115 *² | 650 *² |
| Example 2 | Poly(ethylene succinate) | 100 *¹ | 750 *¹ |
| Example 3 | Poly(butylene succinate adipate) | 84 *² | 250 *² |
| Examples | Blended polymer of poly(butylene | 70 *¹ | 320 *¹ |
| 4 and 5 | succinate adipate):polycaprolactone | | |
| | at 7:3 mass ratio | | |
| Comparative | HDPE | 130 *¹ | 1100 *¹ |
| Example 1 | | | |
| Comparative | EVA 4% | 107 *³ | 200 *³ |
| Example 2 | | | |
| Comparative | EVA 10% | 94 *³ | 100 *³ |
| Example 3 | | | |

*¹ Values measured by inventor, with melting point based on JIS K7121, and flexural modulus based on JIS 7171.
*² Material manufacturer data, with melting point based on ISO 3146, and flexural modulus based on ISO 178.
*³ Material manufacturer data, with melting point based on DSC of JIS K 7121, and flexural modulus based on JIS K 6924-2.

TABLE 2

| | Inner | Membrane | | Defect rate |
|---|---|---|---|---|
| | diameter | thickness | | (%) during |
| | (mm) | (mm) | Polymer tubule material | preparation |
| Example 1 | 0.6 | 0.3 | Poly(butylene succinate) | 0 |
| Example 2 | 0.6 | 0.3 | Poly(ethylene succinate) | 0 |
| Example 3 | 0.6 | 0.3 | Poly(butylene succinate adipate) | 0 |
| Example 4 | 0.6 | 0.3 | Blended polymer of poly(butylene succinate | 1 |
| | | | adipate):polycaprolactone at 7:3 mass ratio | |
| Example 5 | 0.6 | 0.6 | Blended polymer of poly(butylene succinate | 0 |
| | | | adipate):polycaprolactone at 7:3 mass ratio | |
| Comparative | 0.6 | 0.3 | HDPE | 0 |
| Example 1 | | | | |
| Comparative | 0.6 | 0.3 | EVA 4% | 5 |
| Example 2 | | | | |
| Comparative | 0.6 | 0.3 | EVA 10% | 9 |
| Example 3 | | | | |

TABLE 3

| | Release rate (mg/day/tubule) | | | | | |
|---|---|---|---|---|---|---|
| | After 30 | After | After | After | After 150 | |
| | days (a) | 60 days | 90 days | 120 days | days (b) | b/a |
| Example 1 | 0.22 | 0.22 | 0.21 | 0.20 | 0.20 | 0.91 |
| Example 2 | 0.23 | 0.22 | 0.22 | 0.20 | 0.19 | 0.83 |
| Example 3 | 0.19 | 0.19 | 0.16 | 0.14 | 0.14 | 0.74 |
| Example 4 | 0.26 | 0.26 | 0.21 | 0.18 | 0.18 | 0.69 |
| Example 5 | 0.18 | 0.18 | 0.18 | 0.16 | 0.14 | 0.78 |
| Comparative | 0.02 | 0.02 | 0.02 | 0.01 | 0.01 | 0.50 |
| Example 1 | | | | | | |
| Comparative | 0.27 | 0.24 | 0.20 | 0.18 | 0.16 | 0.59 |
| Example 2 | | | | | | |
| Comparative | 0.38 | 0.36 | 0.24 | 0.14 | 0.08 | 0.21 |
| Example 3 | | | | | | |

The defect rate during preparation when the tubule material of the preparation had a vinyl acetate content ratio of 4% by mass was as high as 5%, and increased even more for EVA with 10% by mass. Meanwhile, the defect rates of the containers during preparation for Examples 1 to 5, which contained at least linear aliphatic polyester, were 1% or lower, and were less than those of Comparative Examples 2 and 3. Although the preparation materials of Examples 2 to 5 had lower melting points than the vinyl acetate copolymers with vinyl acetate content ratios of 4%, it is considered that a reason for the reduced defect rate during preparation was the high flexural moduli.

The high-density polyethylene of Comparative Example 1 substantially did not release 3,5-dimethyldodecanoic acid, whereas the release rates were significantly high for the EVA resins of Comparative Examples 2 and 3. In particular, the latter had a large initial release that decreased over time. Comparing the release rates after 30 days (a) and after 150 days (b), the value of b/a was 0.59 or lower, indicating relatively low uniformity of release, and the effective life of the preparation is expected to be short. Meanwhile, the linear aliphatic polyesters had values of b/a of 0.69 or higher, indicating high uniformity, and the effective lives of the preparations are expected to be long. The release behavior under the conditions of the Examples and Comparative Examples correlates with the release behavior in an actual field, and similar release behavior was confirmed in an actual field.

1. A sustained release pheromone preparation comprising at least:
a carboxylic acid compound, the carboxylic acid compound being a sex pheromone; and
a container having the carboxylic acid compound enclosed therein,
wherein the container comprises, as at least a part of the container, a membrane of a linear aliphatic polyester having at least one selected from the following repeating unit (I): 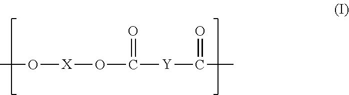
in which X and Y represent, independently of each other, a divalent hydrocarbon group having 1 to 8 carbon atoms.

2. The sustained release pheromone preparation according to claim 1, wherein the linear aliphatic polyester is selected from the group consisting of poly(ethylene succinate), poly(ethylene adipate), poly(butylene succinate), poly(butylene adipate), and poly(butylene succinate adipate).

3. The sustained release pheromone preparation according to claim 1, wherein the carboxylic acid compound has 6 to 21 carbon atoms, including the carbon atoms of the carboxyl groups.

4. A method for controlling a pest, the method comprising at least a step of placing the sustained release pheromone preparation according to claim 1 in a field to release the aforesaid carboxylic acid compound from inside the sustained release pheromone preparation.

5. A method for controlling a pest, the method comprising at least a step of placing the sustained release pheromone preparation according to claim 2 in a field to release the aforesaid carboxylic acid compound from inside the sustained release pheromone preparation.

6. A method for controlling a pest, the method comprising at least a step of placing the sustained release pheromone preparation according to claim 3 in a field to release the aforesaid carboxylic acid compound from inside the sustained release pheromone preparation.
